(19) United States
(12) Patent Application Publication
(10) Pub. No.: US 2024/0189804 A1
(43) Pub. Date: Jun. 13, 2024

(54) Cu-SAPO-34 CATALYST AND PREPARATION METHOD AND USE THEREOF

(71) Applicant: Dalian Maritime University, Dalian (CN)

(72) Inventors: Xiaofeng WANG, Dalian (CN); Mengyue QIN, Dalian (CN); Qingbo LI, Dalian (CN)

(21) Appl. No.: 18/172,132

(22) Filed: Feb. 21, 2023

(30) Foreign Application Priority Data
Dec. 12, 2022 (CN) 202211610475.3

(51) Int. Cl. B01J 29/85; B01J 37/00; B01J 37/03; B01J 37/04; B01J 37/08

(52) U.S. Cl. CPC B01J 29/85; B01J 37/0018; B01J 37/031; B01J 37/04; B01J 37/088

(57) ABSTRACT

The present disclosure belongs to the technical field of denitration catalysts, and provides a Cu-SAPO-34 catalyst and a preparation method and use thereof. In the preparation method provided by the present disclosure, during crystallization growth, an aluminum precursor, a phosphorus precursor, a silicon precursor, and a copper complex form a Cu-SAPO-34 molecular sieve catalyst under the guiding action of a template morpholine, and the template in the Cu-SAPO-34 molecular sieve catalyst is removed by roasting to obtain the Cu-SAPO-34 catalyst. In the preparation method, a molar ratio of phosphorus and aluminum in the Cu-SAPO-34 catalyst is controlled at (0.1-5):1, thereby increasing a particle size and a specific surface area of the Cu-SAPO-34 catalyst, which is conducive to adsorption of a reaction gas to improve a denitration efficiency. Meanwhile, aggregation of Cu²⁺ after hydrothermal aging of the Cu-SAPO-34 catalyst is suppressed, thereby improving a hydrothermal stability of the Cu-SAPO-34 catalyst.

### CROSS REFERENCE TO RELATED APPLICATION(S)

This patent application claims the benefit and priority of Chinese Patent Application No. 202211610475.3, filed on Dec. 12, 2022, the disclosure of which is incorporated by reference herein in its entirety as part of the present application.

### TECHNICAL FIELD

The present disclosure relates to the technical field of denitration catalysts, in particular to a Cu-SAPO-34 catalyst and a preparation method and use thereof.

### BACKGROUND

Nitrogen oxides emitted from mobile sources such as diesel-powered ships contribute to the formation of smog, which have harmful effects on human health and the environment. In order to reduce nitrogen oxide emissions, ammonia selective catalytic reduction (NH₃-SCR) technology has been applied to diesel engines as an engine post-treatment system. A typical post-treatment system includes a diesel oxidation catalyst (DOC) device, a diesel particulate filter (DPF), an SCR device, and an ammonia slip controller (ASC). During the periodic regeneration of DPF, an SCR catalyst in the SCR system inevitably encounters high-temperature steam, such that the SCR catalyst must have desirable hydrothermal stability. In addition, the combustion of sulfur in diesel produces SO₂. When passing through a catalyst in the upstream DOC device, a certain proportion of the SO₂ may be further oxidized to SO₃/H₂SO₄, causing more serious poisoning to the downstream SCR catalyst continuously exposed to the engine exhaust containing SO₂/SO₃. Therefore, in order to achieve a desirable denitration effect and ensure a service life of the SCR catalyst, higher requirements are put forward for a hydrothermal stability of the SCR denitration catalyst in the SCR device. Meanwhile, the SCR denitration catalyst must have certain sulfur resistance.

Cu-SAPO-34 catalyst is a commonly used SCR catalyst. However, the Cu-SAPO-34 catalyst has poor hydrothermal stability and sulfur tolerance. The deactivation of Cu-SAPO-34 catalyst during the hydrothermal aging is mainly due to the catalyst structure destruction caused by high temperature. In addition, Cu²⁺ in the Cu-SAPO-34 catalyst, as active sites in the pores of a molecular sieve, may accumulate to form CuO during the hydrothermal aging, and the formation of CuO can lead to reduction of the active sites and the occurrence of harmful side reactions, such as NH₃ oxidation. The deactivation of Cu-SAPO-34 catalyst under the action of SOₓ is mainly due to the breakage of Si—O(H)—Al bonds, resulting in the formation of aluminum sulfate when SOₓ is sulfated. Therefore, it is urgent to provide a Cu-SAPO-34 catalyst with excellent hydrothermal stability and sulfur tolerance.

### SUMMARY

In view of this, an objective of the present disclosure is to provide a Cu-SAPO-34 catalyst and a preparation method and use thereof. In the present disclosure, the Cu-SAPO-34 catalyst prepared by the preparation method has excellent sulfur resistance and hydrothermal stability.

To achieve the above objective, the present disclosure provides the following technical solutions.

The present disclosure provides a preparation method of a Cu-SAPO-34 catalyst, including the following steps:
mixing an aluminum precursor, a phosphorus precursor, a silicon precursor, and a template with water to obtain a molecular sieve precursor solution;
mixing a copper precursor with a ligand, and conducting complexation to obtain a copper complex;
mixing the molecular sieve precursor solution with the copper complex, and conducting crystallization growth to obtain a catalyst precursor; and
roasting the catalyst precursor to obtain the Cu-SAPO-34 catalyst; where
phosphorus in the phosphorus precursor and aluminum in the aluminum precursor have a molar ratio of (0.1-5):1; and
the template includes morpholine.

Preferably, the aluminum precursor is one or more selected from the group consisting of aluminum hydroxide, aluminum chloride, aluminum sulfate, aluminum nitrate, pseudoboehmite, and aluminum isopropoxide; the phosphorus precursor is one or more selected from the group consisting of aluminum phosphate, phosphoric acid, and phosphorus pentoxide; and the silicon precursor is one or more selected from the group consisting of silica sol, white carbon black, silica, and silicic acid.

Preferably, silicon in the silicon precursor and the aluminum in the aluminum precursor have a molar ratio of (0.1-1.5):1.

Preferably, the template and the aluminum in the aluminum precursor have a molar ratio of (0.1-2):1.

Preferably, the copper precursor is one or more selected from the group consisting of copper nitrate, copper chloride, and copper sulfate; the ligand is tetraethylenepentamine; the copper precursor and the ligand have a molar ratio of (0.01-0.5):1; and the complexation is conducted at 20° C. to 50° C. for 1 h to 4 h.

Preferably, the copper complex and the aluminum in the aluminum precursor have a molar ratio of (0.01-0.3):1.

Preferably, the crystallization growth is conducted at 150° C. to 250° C. for 12 h to 48 h.

Preferably, the roasting is conducted at 300° C. to 550° C. for 5 h to 10 h.

The present disclosure further provides a Cu-SAPO-34 catalyst prepared by the preparation method.

The present disclosure further provides use of the Cu-SAPO-34 catalyst in denitration.

The present disclosure provides a preparation method of a Cu-SAPO-34 catalyst, including the following steps: mixing an aluminum precursor, a phosphorus precursor, a silicon precursor, and a template with water to obtain a molecular sieve precursor solution; mixing a copper precursor with a ligand, and conducting complexation to obtain a copper complex; mixing the molecular sieve precursor solution with the copper complex, and conducting crystallization growth to obtain a catalyst precursor; and roasting the catalyst precursor to obtain the Cu-SAPO-34 catalyst; where phosphorus in the phosphorus precursor and aluminum in the aluminum precursor have a molar ratio of (0.1-5):1; and the template includes morpholine. In the present disclosure, during crystallization growth, an aluminum precursor, a phosphorus precursor, a silicon precursor, and a copper complex form a Cu-SAPO-34 molecular sieve catalyst under the guiding action of a template morpholine, and the template in the Cu-SAPO-34 molecular sieve catalyst is removed by roasting to obtain the Cu-SAPO-34 catalyst. In the preparation method, a molar ratio of phosphorus and aluminum in the Cu-SAPO-34 catalyst is controlled at (0.1-5):1, thereby increasing a particle size and a specific surface area of the Cu-SAPO-34 catalyst, which is conducive to adsorption of a reaction gas to improve denitration efficiency. Meanwhile, aggregation of Cu²⁺ after hydrothermal aging of the Cu-SAPO-34 catalyst is suppressed, thereby improving a hydrothermal stability of the Cu-SAPO-34 catalyst. The Cu-SAPO-34 catalysts with different phosphorus/aluminum ratios prepared by the method have relatively-high particle size, specific surface area, and pore volume. The high specific surface area is conducive to providing more active sites, and the high pore volume reduces a degree of sulfate blocking the pore size. Accordingly, the catalyst exhibits the resistance to SO₂.

The present disclosure further provides a Cu-SAPO-34 catalyst prepared by the preparation method. The Cu-SAPO-34 catalyst has excellent hydrothermal stability and sulfur resistance, and can be well applied to denitration.

### BRIEF DESCRIPTION OF THE DRAWINGS

FIG. 1 shows a scanning electron microscopy (SEM) image of a Cu-SAPO-34-1.2 catalyst obtained in Example 3;

FIG. 2 shows changes of a NOx conversion rate with temperature before and after hydrothermal aging of the Cu-SAPO-34 catalyst at 700° C. for 12 h; where Cu-SAPO-34-0.8 and Cu-SAPO-34-0.8-A represent the catalysts of Cu-SAPO-34-0.8 before and after hydrothermal aging, respectively; and Cu-SAPO-34-1.2 and Cu-SAPO-34-1.2-A represent the catalysts of Cu-SAPO-34-1.2 before and after hydrothermal aging, respectively; and

FIG. 3 shows changes of a NOx conversion ratio with time in the presence of 100 ppm of SO₂ for the Cu-SAPO-34-0.8 catalyst obtained in Example 1 and the Cu-SAPO-34-1.2 catalyst obtained in Example 3.

### DETAILED DESCRIPTION OF THE EMBODIMENTS

The present disclosure provides a preparation method of a Cu-SAPO-34 catalyst, including the following steps:
mixing an aluminum precursor, a phosphorus precursor, a silicon precursor, and a template with water to obtain a molecular sieve precursor solution;
mixing a copper precursor with a ligand, and conducting complexation to obtain a copper complex;
mixing the molecular sieve precursor solution with the copper complex, and conducting crystallization growth to obtain a catalyst precursor; and
roasting the catalyst precursor to obtain the Cu-SAPO-34 catalyst; where
phosphorus in the phosphorus precursor and aluminum in the aluminum precursor have a molar ratio of (0.1-5):1; and
the template includes morpholine.

In the present disclosure, the raw materials provided herein are all preferably commercially-available products unless otherwise specified.

In the present disclosure, an aluminum precursor, a phosphorus precursor, a silicon precursor, and a template are mixed with water to obtain a molecular sieve precursor solution.

In the present disclosure, the aluminum precursor is preferably one or more selected from the group consisting of aluminum hydroxide, aluminum chloride, aluminum sulfate, aluminum nitrate, pseudoboehmite, and aluminum isopropoxide, more preferably the pseudoboehmite.

In the present disclosure, the phosphorus precursor is preferably one or more selected from the group consisting of aluminum phosphate, phosphoric acid, and phosphorus pentoxide, more preferably the phosphoric acid.

In the present disclosure, the silicon precursor is preferably one or more selected from the group consisting of silica sol, white carbon black, silica, and silicic acid, more preferably the silica sol.

In the present disclosure, the template includes morpholine.

In the present disclosure, phosphorus in the phosphorus precursor and aluminum in the aluminum precursor have a molar ratio of (0.1-5):1, preferably (0.8-2):1, more preferably (1-1.4):1, and even more preferably 1.2:1.

In the present disclosure, silicon in the silicon precursor and the aluminum in the aluminum precursor have a molar ratio of preferably (0.1-1.5):1, more preferably (0.2-1):1, more preferably (0.3-0.5):1.

In the present disclosure, the template and the aluminum in the aluminum precursor have a molar ratio of preferably (0.1-2):1, more preferably (0.5-1.8): 1, and more preferably (1-1.65):1.

In the present disclosure, the aluminum precursor and water have a dosage ratio of preferably 0.049 mol:30 mL.

In the present disclosure, a process of mixing the aluminum precursor, the phosphorus precursor, the silicon precursor, and the template with water preferably includes: conducting first mixing on the aluminum precursor, the phosphorus precursor, the silicon precursor, and water, and then adding the template to conducting second mixing. There is no special limitation on a manner of the first mixing and the second mixing, as long as the raw materials can be mixed uniformly.

In the present disclosure, a copper precursor is mixed with a ligand, and complexation is conducted to obtain a copper complex.

In the present disclosure, the copper precursor is preferably one or more selected from the group consisting of copper nitrate, copper chloride, and copper sulfate.

In the present disclosure, the ligand is preferably tetraethylenepentamine.

In the present disclosure, the copper precursor and the ligand have a molar ratio of preferably (0.01-0.5):1, more preferably (0.011-0.4):1.

In the present disclosure, the complexation is conducted at preferably 20° C. to 50° C., more preferably 25° C. to 40° C. for preferably 1 h to 4 h under preferably stirring.

In the present disclosure, after the complexation, subsequent reactions are preferably conducted directly without any post-treatment.

In the present disclosure, the molecular sieve precursor solution is mixed with the copper complex, and crystallization growth is conducted to obtain a catalyst precursor.

In the present disclosure, in the copper complex and the molecular sieve precursor solution, the aluminum in the aluminum precursor has a molar ratio of preferably (0.01-0.3):1, more preferably (0.04-0.2):1, and even more preferably (0.06-0.1):1.

In the present disclosure, the crystallization growth is conducted at preferably 150° C. to 250° C., more preferably 170° C. to 230° C., and even more preferably 190° C. to 210° C. for preferably 12 h to 48 h, more preferably 24 h to 36 h.

In the present disclosure, the crystallization growth is conducted preferably in a hydrothermal reactor.

In the present disclosure, after the crystallization growth, a crystallization growth system is preferably washed and subjected to solid-liquid separation in sequence, and an obtained solid is dried. A washing agent is preferably one or more selected from the group consisting of distilled water, deionized water, and ethanol.

In the present disclosure, during crystallization growth, the aluminum precursor, the phosphorus precursor, the silicon precursor, and the copper complex form a Cu-SAPO-34 catalyst precursor under the guiding action of the template morpholine.

In the present disclosure, the catalyst precursor is roasted to obtain the Cu-SAPO-34 catalyst.

In the present disclosure, the roasting is conducted at preferably 300° C. to 550° C., more preferably 350° C. to 500° C., and even more preferably 400° C. to 450° C. for preferably 5 h to 10 h, more preferably 6 h to 9 h, and even more preferably 7 h to 8 h. The roasting temperature is obtained by heating at preferably 5° C./min to 10° C./min. The roasting is conducted in preferably an air atmosphere.

In the present disclosure, the roasting can remove the template in the catalyst precursor.

The present disclosure further provides a Cu-SAPO-34 catalyst prepared by the preparation method. The Cu-SAPO-34 catalyst has excellent hydrothermal stability and sulfur resistance.

The present disclosure further provides use of the Cu-SAPO-34 catalyst in denitration. In the present disclosure, there is no special limitation on an application mode of the Cu-SAPO-34 catalyst, and those skilled in the art can use the catalyst according to actual needs.

The Cu-SAPO-34 catalyst and the preparation method and the use thereof provided by the present disclosure will be described in detail below with reference to examples, but these examples should not be construed as limiting the scope of the present disclosure.

### Example 1

### Preparation of a Cu-SAPO-34 Catalyst:

0.049 mol (calculated as aluminum) of an Al precursor (pseudoboehmite), 30 mL of distilled water, 0.039 mol (calculated as phosphorus) of a phosphorus precursor (phosphoric acid), 0.015 mol (calculated as silicon) of a silicon precursor (silica sol), 0.079 mol of morpholine, and 0.003 mol of Cu-TEPA were mixed by stirring and added into a hydrothermal reactor, and heated to 200° C. to conduct crystallization growth for 48 h. A resulting suspension was washed, centrifuged, and dried to obtain a catalyst precursor.

The catalyst precursor was heated to 550° C. at 10° C./min in an air atmosphere and the temperature was held for 5 h to obtain Cu-SAPO-34 with a P/Al ratio of 0.8, denoted as Cu-SAPO-34-0.8.

A preparation method of the Cu-TEPA included:
a copper precursor (CuSO₄) was mixed with tetraethylenepentamine at a molar ratio of 0.012:1, and subjected to complexation at 25° C. for 60 min to obtain the copper-amine complex (Cu-TEPA).

### Example 2

This example differed from Example 1 in that: 0.049 mol of the Al precursor and 0.049 mol of the phosphorus precursor were used to obtain Cu-SAPO-34 with a P/Al ratio of 1.0, denoted as Cu-SAPO-34-1.0.

### Example 3

This example differed from Example 1 in that: 0.049 mol of the Al precursor and 0.059 mol of the phosphorus precursor were used to obtain Cu-SAPO-34 with a P/Al ratio of 1.2, denoted as Cu-SAPO-34-1.2.

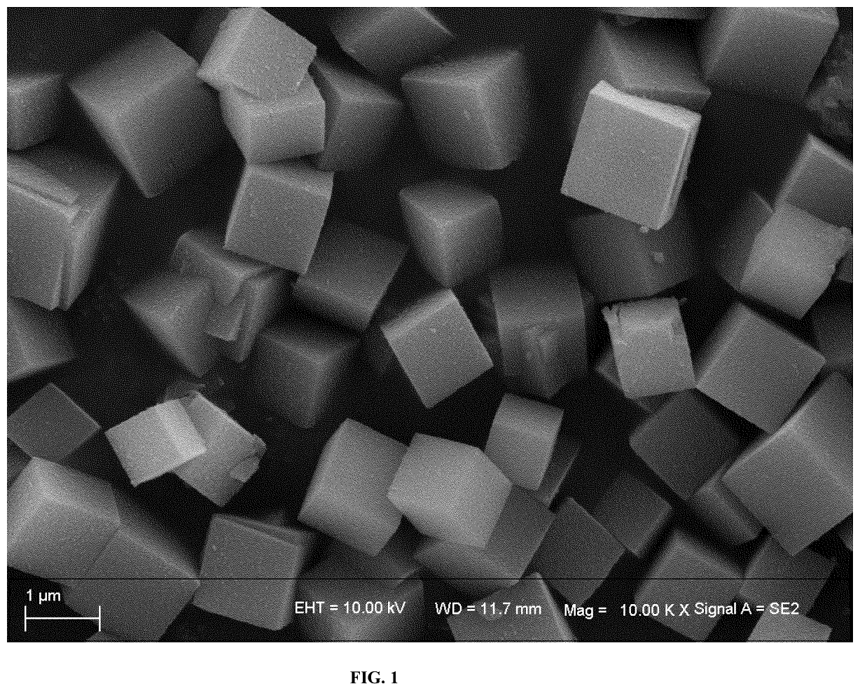

FIG. 1 showed a SEM image of the Cu-SAPO-34-1.2 catalyst obtained in Example 3. It was seen from FIG. 1 that the Cu-SAPO-34-1.2 catalyst presented a uniform cubic structure after roasting.

### Example 4

This example differed from Example 1 in that: 0.049 mol of the Al precursor and 0.069 mol of the phosphorus precursor were used to obtain Cu-SAPO-34 with a P/Al ratio of 1.4, denoted as Cu-SAPO-34-1.4.

### Example 5

This example differed from Example 1 in that: 0.049 mol of the Al precursor and 0.098 mol of the phosphorus precursor were used to obtain Cu-SAPO-34 with a P/Al ratio of 2, denoted as Cu-SAPO-34-2.

### Test Example

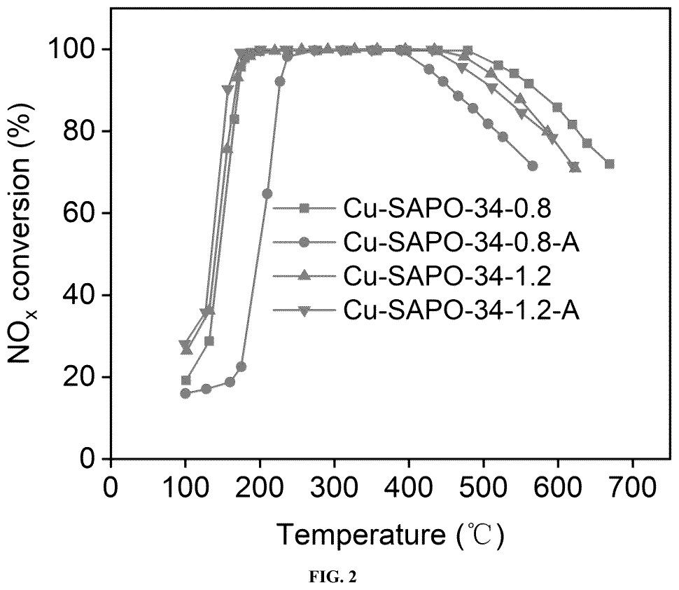

Hydrothermal stability test: the Cu-SAPO-34 catalyst (Cu-SAPO-34-0.8) obtained in Example 1 and the Cu-SAPO-34 catalyst (Cu-SAPO-34-1.2) obtained in Example 3 were packed in a self-made quartz reaction tube, a mixed gas (including 1,000 ppm of NO, 1,000 ppm of NH₃, 5% of O₂, and N₂ as a balance) was introduced, a gas-firing hourly space velocity (GHSV) was adjusted to 110,000 h⁻¹, and a temperature was raised during the test (gradually increasing from 100° C. to 700° C.) to test an activity; at each temperature point (100° C., 150° C., 180° C., 200° C., 250° C., 300° C., 400° C., 450° C., 500° C., 600° C., and 700° C.), a NO concentration was detected by a flue gas analyzer, and an amount of N₂O produced was detected by a laughing gas detector; a NOx conversion rate of Cu-SAPO-34-0.8 and Cu-SAPO-34-1.2 before and after hydrothermal aging was studied separately, and the results were shown in FIG. 2. It was seen from FIG. 2 that before hydrothermal aging, the Cu-SAPO-34-0.8 and Cu-SAPO-34-1.2 had similar NO conversion rates; however, after hydrothermal aging, the Cu-SAPO-34-1.2 with a high P/Al ratio maintained a wide temperature window and had a better low-temperature activity.

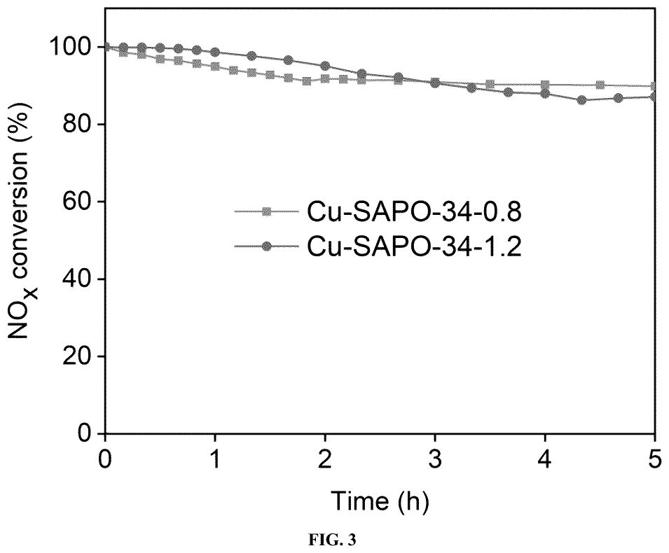

Sulfur tolerance test: the Cu-SAPO-34 catalyst (Cu-SAPO-34-0.8) obtained in Example 1 and the Cu-SAPO-34 catalyst (Cu-SAPO-34-1.2) obtained in Example 3 were packed in a self-made quartz reaction tube, a mixed gas (including 1,000 ppm of NO, 1,000 ppm of NH₃, 5% of O₂, 100 ppm of SO₂, and N₂ as a balance) was introduced, a gas-firing hourly space velocity (GHSV) was adjusted to 110,000 h⁻¹, and a temperature was set at 300° C. to test an activity; at each time point (0 h, 0.2 h, 0.3 h, 0.5 h, 1 h, 1.5 h, 2 h, 2.5 h, 3 h, 3.5 h, 4 h, 4.5 h, and 5 h), a NO concentration was detected by a flue gas analyzer, and an amount of N₂O produced was detected by a laughing gas detector; the sulfur tolerance of the Cu-SAPO-34 catalyst was determined, and the results were shown in FIG. 3. It was seen from FIG. 3 that Cu-SAPO-34-0.8 and Cu-SAPO-34-1.2 each exhibited similar and excellent sulfur resistance.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1.-10. (canceled)

11. A preparation method of a Cu-SAPO-34 catalyst, comprising the following steps:
mixing an aluminum precursor, a phosphorus precursor, a silicon precursor, and a template with water to obtain a molecular sieve precursor solution;
mixing a copper precursor with a ligand, and conducting complexation to obtain a copper complex;
mixing the molecular sieve precursor solution with the copper complex, and conducting crystallization growth to obtain a catalyst precursor; and
roasting the catalyst precursor to obtain the Cu-SAPO-34 catalyst; wherein
phosphorus in the phosphorus precursor and aluminum in the aluminum precursor have a molar ratio of (0.1-5):1; and
the template comprises morpholine.

12. The preparation method according to claim 11, wherein the aluminum precursor is one or more selected from the group consisting of aluminum hydroxide, aluminum chloride, aluminum sulfate, aluminum nitrate, pseudoboehmite, and aluminum isopropoxide; the phosphorus precursor is one or more selected from the group consisting of aluminum phosphate, phosphoric acid, and phosphorus pentoxide; and the silicon precursor is one or more selected from the group consisting of silica sol, white carbon black, silica, and silicic acid.

13. The preparation method according to claim 11, wherein silicon in the silicon precursor and the aluminum in the aluminum precursor have a molar ratio of (0.1-1.5):1.

14. The preparation method according to claim 12, wherein silicon in the silicon precursor and the aluminum in the aluminum precursor have a molar ratio of (0.1-1.5):1.

15. The preparation method according to claim 11, wherein the template and the aluminum in the aluminum precursor have a molar ratio of (0.1-2):1.

16. The preparation method according to claim 12, wherein the template and the aluminum in the aluminum precursor have a molar ratio of (0.1-2):1.

17. The preparation method according to claim 11, wherein the copper precursor is one or more selected from the group consisting of copper nitrate, copper chloride, and copper sulfate; the ligand is tetraethylenepentamine; the copper precursor and the ligand have a molar ratio of (0.01-0.5):1; and the complexation is conducted at 20° C. to 50° C. for 1 h to 4 h.

18. The preparation method according to claim 11, wherein the copper complex and the aluminum in the aluminum precursor have a molar ratio of (0.01-0.3):1.

19. The preparation method according to claim 11, wherein the copper complex and the aluminum in the aluminum precursor have a molar ratio of (0.01-0.3):1.

20. The preparation method according to claim 11, wherein the crystallization growth is conducted at 150° C. to 250° C. for 12 h to 48 h.

21. The preparation method according to claim 11, wherein the roasting is conducted at 300° C. to 550° C. for 5 h to 10 h.

22. A Cu-SAPO-34 catalyst prepared by the preparation method according to claim 11.

23. The Cu-SAPO-34 catalyst according to claim 22, wherein the aluminum precursor is one or more selected from the group consisting of aluminum hydroxide, aluminum chloride, aluminum sulfate, aluminum nitrate, pseudoboehmite, and aluminum isopropoxide; the phosphorus precursor is one or more selected from the group consisting of aluminum phosphate, phosphoric acid, and phosphorus pentoxide; and the silicon precursor is one or more selected from the group consisting of silica sol, white carbon black, silica, and silicic acid.

24. The Cu-SAPO-34 catalyst according to claim 22, wherein silicon in the silicon precursor and the aluminum in the aluminum precursor have a molar ratio of (0.1-1.5):1.

25. The Cu-SAPO-34 catalyst according to claim 23, wherein silicon in the silicon precursor and the aluminum in the aluminum precursor have a molar ratio of (0.1-1.5):1.

26. The Cu-SAPO-34 catalyst according to claim 22, wherein the template and the aluminum in the aluminum precursor have a molar ratio of (0.1-2):1.

27. The Cu-SAPO-34 catalyst according to claim 22, wherein the copper precursor is one or more selected from the group consisting of copper nitrate, copper chloride, and copper sulfate; the ligand is tetraethylenepentamine; the copper precursor and the ligand have a molar ratio of (0.01-0.5):1; and the complexation is conducted at 20° C. to 50° C. for 1 h to 4 h.

28. The Cu-SAPO-34 catalyst according to claim 22, wherein the copper complex and the aluminum in the aluminum precursor have a molar ratio of (0.01-0.3):1.

29. The Cu-SAPO-34 catalyst according to claim 22, wherein the crystallization growth is conducted at 150° C. to 250° C. for 12 h to 48 h.

30. The Cu-SAPO-34 catalyst according to claim 22, wherein the roasting is conducted at 300° C. to 550° C. for 5 h to 10 h.
